(19) United States
(12) Patent Application Publication
(10) Pub. No.: US 2003/0177447 A1
(43) Pub. Date: Sep. 18, 2003

(54) Apparatus and method for providing information

(76) Inventor: Amelia Newbury, Cambridge, MA (US)

Correspondence Address: BROMBERG & SUNSTEIN LLP, 125 SUMMER STREET, BOSTON, MA, 02110-1618, US

(21) Appl. No.: 10/357,308

(22) Filed: Feb. 3, 2003

Related U.S. Application Data
(60) Provisional application No. 60/353,239, filed on Feb. 1, 2002.

(51) Int. Cl. G06F 15/00

(52) U.S. Cl. 715/522

(57) ABSTRACT

A computer product provides interactive content for use in a computer system that optionally includes a network of computers. The computer product comprises:

a digital storage medium, the storage medium encoded with computer readable files as follows:

a first set of files providing interactive content using a markup language format and a script format, the scripting language for controlling data conmmunication between a user and a program source;

a second set of files providing compatibility of the interactive content for use with a first e-learning standard environment; and

a third set of files providing compatibility of the interactive content for use with a second e-learning standard environment.

The present application claims priority from U.S. Provisional Application Ser. No. 60/353,239, filed Feb. 1, 2002, which is hereby incorporated herein, in its entirety, by reference.

### TECHNICAL FIELD

The present invention relates to network based learning environments and, more particularly to providing an apparatus and methods for distributing interactive content regardless of particular access requirements.

### BACKGROUND ART

It is known in the art to provide Web browsers to display Web pages over a network such as the Internet. While browsers are now so widely distributed that they can be used as interfaces for various programs, Internet access constraints have traditionally prevented the distribution of interactive content in one single universal format. Clients with different types of access needs all want the same interactive content, and companies who want to host a particular content have different server environments into which they want to integrate the content. Maintaining multiple versions of the same interactive content to cover distribution needs is typically messy and expensive.

In the HTML environment, it is known for a web server to utilize a short-form message format, termed a “cookie”, for communication with a computer accessing web pages via a web browser. The browser environment will store such a message, for example, in a text file called “cookie.txt.” The message may then be sent back to the server each time the browser requests a page from the server. Cookies may be used to identify users and prepare customized Web pages for them. When a user enters a Web site using cookies, he or she may be asked to fill out a form providing such information as the user's name and interests. This information is packaged into a cookie and sent to the Web browser to store for later use. The next time the user enters the same Web site, the browser will send the cookie to the Web server. The server can use the information to present the user with a custom Web page. For example, instead of seeing just a generic welcome page, the user might see a welcome page with his or her name on it. Cookies are derived from UNIX objects called “magic cookies.” These are tokens that are attached to a user or program which change depending on the areas entered by the user or program. Cookies are sometimes called “persistent cookies” because they typically stay in the browser for long periods of time. Cookie data can be associated with a user and saved to a database. This allows the data to be written to the client machine the next time a program is accessed, and compensates for the possibility that a cookie could be overwritten by the browser. Information regarding cookies and their use may be found at www.cookiecentral.com and specific programming details and usages appear at www.cookiecentral.com/faq/#3. The documents on this web site are hereby incorporated herein by reference.

Integration flexibility now exists with the introduction of the AICC and SCORM standards into the traditional interactive training and eLearning systems. AICC, the Aviation Industry CBT (Computer Based Training) Committee, is an international association of technology based training professionals. The AICC promotes interoperability standards that software vendors can use across multiple industries. AICC recommendations are fairly general to most types of computer based training, and for this reason are widely used outside of the aviation training industry. Further details are available at the web site of the AICC, www.aicc.org. Technical standards of the AICC are accessible from the web site. At the time of this writing the technical standards could be found at www.aicc.org/pages/down-docs-index.htm#WHITE. SCORM, Sharable Content Object Reference Model, is an XML-based reference model that defines a Web based learning “content model.” The SCORM standards are distributed by Advanced Distributed Learning Initiative Network, which has a web site setting forth these standards at www.adlnet.org. See also, for example, “R., Cover, “Shareable Content Object Reference Model Initiative (SCORM)” in The XML Cover Pages at http://xml.coverpages.org/scorm.html. The foregoing web-based documents are hereby incorporated herein by reference.

### SUMMARY OF THE INVENTION

In a first embodiment, computer product provides interactive content for use in a computer system that optionally includes a network of computers. The computer product comprises:

a digital storage medium, the storage medium encoded with computer readable files as follows:

a first set of files providing interactive content using a markup language format and a script format, the scripting language for controlling data communication between a user and a program source;

a second set of files providing compatibility of the interactive content for use with a first e-learning standard environment; and

a third set of files providing compatibility of the interactive content for use with a second e-learning standard environment.

In a related embodiment, the computer product also includes a fourth set of files, which may be included in any of the other sets of files, for identifying the nature of an e-learning environment in which interactive content has been placed, and invoking processes for providing data pass consistent with the thus identified e-learning environment, or providing no data pass at all.

In related embodiments of the invention, the first e-learning standard environment may comply with AICC standards. In other related embodiments of the invention, the second e-learning standard environment may comply with SCORM standards. In additional related embodiments, the scripting language is selected from the group consisting of JavaScript, ASP script, and PHP script.

In accordance with another embodiment of the invention, a method of providing interactive content, for use in a computer system that optionally includes a network of computers, includes:

providing interactive content using a markup language format;

along with the provided content, providing a first set of files providing compatibility of the interactive content for use with a first e-learning standard environment and a second set of files providing compatibility of the interactive content for use with a second e-learning standard environment;

in the course of providing interactive content, identifying the nature of an e-learning environment in which interactive content has been placed;

for each user experiencing the interactive content, using a cookie to provide a record of the user's place in experiencing of the interactive content.

In accordance with a related embodiment, the cookie may also provide a record of the user's data in experiencing of the interactive content. In accordance with another related embodiment, the content is provided in a computing environment devoid of a network of computers.

### BRIEF DESCRIPTION OF THE DRAWINGS

The foregoing features of the invention will be more readily understood by reference to the following detailed description, taken with reference to the accompanying drawings, in which:

FIG. 1 is a block diagram illustrating an apparatus for providing information in accordance with one embodiment of the present invention;

FIG. 2 is a flow chart illustrating a method for providing information when no database is available;

FIG. 3 is a flow chart illustrating a method for providing information in accordance with proprietary or non-standards based server access;

FIG. 4 is a flow chart illustrating a method for providing information in accordance with standards based server access; and

FIG. 5 is an illustration of a graphical user interface for accessing files in accordance with the embodiments of FIGS. 1-4.

### DETAILED DESCRIPTION OF SPECIFIC EMBODIMENTS

Definitions: For the purpose of the present description, the following terms shall have the indicated meanings unless the context otherwise requires:

“Content” refers to information in an interactive format.

A “content package” refers to content and additional files that permit the content to be compatible with a plurality of interactive content environments in accordance with embodiments of the present invention.

Embodiments of the invention allow interactive content to be delivered to the widest audience possible. In this manner, content remains the focus, and does not have to bend to fit distribution needs.

In accordance with embodiments of the invention, one version of the same course content is allowed to work with a plurality of different distribution methods. Such distribution methods include, but are not limited to: Internet delivery from a server using a standards compliant database or system; Internet delivery from a server using a non-standards compliant database or system; firewall delivery from a server using a standards compliant database or system; firewall delivery from a server using a non-standards compliant database or system; Intranet/Internet delivery from a server with no database; and distribution on CD or from any computer media with enough space to hold the content. In this manner, embodiments of the invention may be used in a stand-alone environment or in a network environment.

The course content itself has been separated from the technical implementation files, allowing this process to apply to virtually any content. Embodiments of the invention allow course content interaction to be the same for all access methods, provide a simple implementation file package to fit all environments mentioned above, and enable the course to detect its environment. Instrumentality may be constrained to degrade gracefully so as to enable the experience of the content, regardless of client limitations. Database systems here may hold data from client side cookies so the user identifier and experience data (the interactive responses) can be saved and passed from machine to machine.

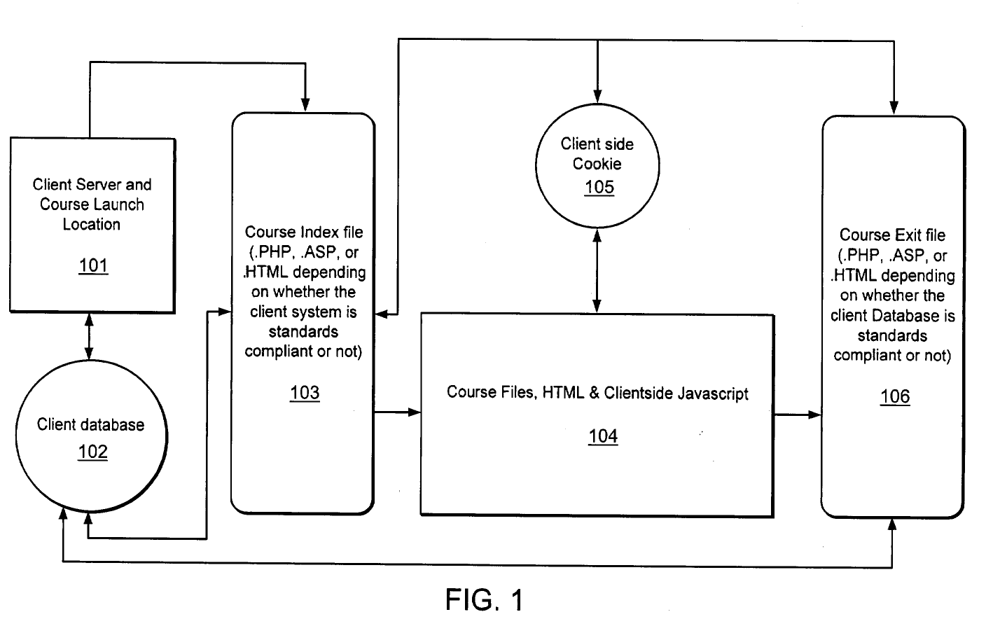

FIG. 1 is a block diagram illustrating components for providing content in accordance with one embodiment of the present invention. Such an embodiment may be used with a course that provides interactivity through an interactive case and short practice activities, along with expert feedback for self-evaluation. A section of the course with interactive online tools also helps the user prepare, practice, and review key concepts as they work. The interactive content is written in HTML, using client side JavaScript and the appropriate server side scripts to go through the steps outlined below. (Although JavaScript has been employed here, any other suitable scripting language for controlling data commands may be employed, such as ASP (Active Server Pages}), PHP (short for PHP: Hypertext Preprocessor) script.

In accordance with embodiments of the invention, a client server 101 may or may not be in communication with a client database 102. The client server 101 and client database 102, if present, have access to a content package which includes course Index files 103, course content 104, course Exit files 106, SCORM and AICC files for standards based server integration and PHP and ASP files for a proprietary server implementation.

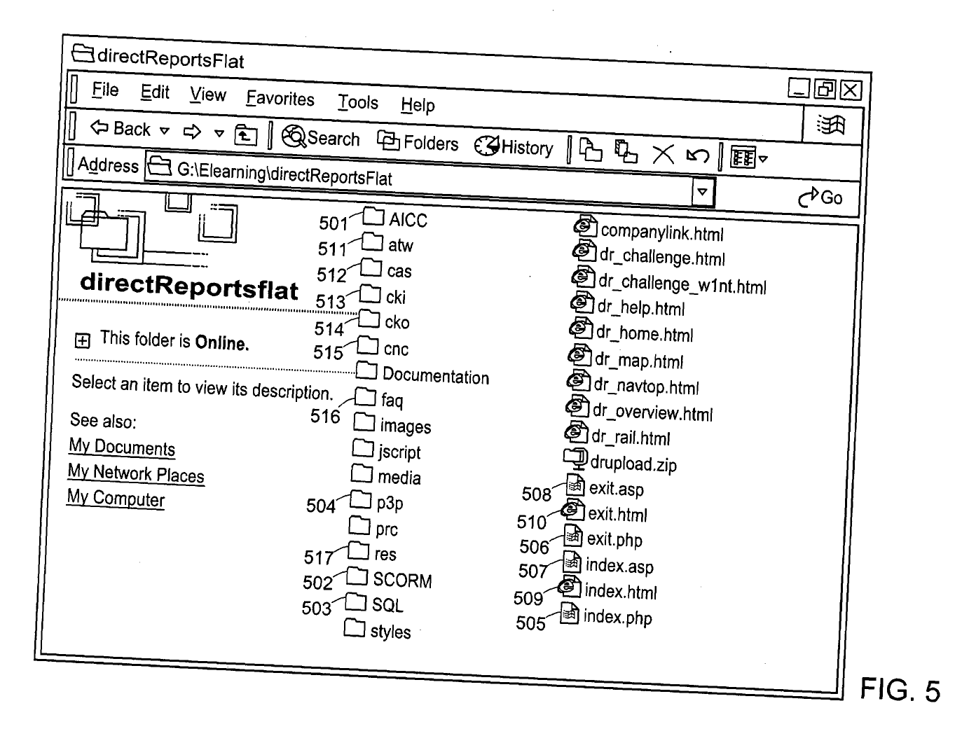

The implementation files included in the content package 103, 104 and 106 for this embodiment are shown in FIG. 5 and code pertaining to these files is included in Appendix A attached hereto. This code implements some of following eleven steps described in further detail below:

1. The client starts the content.

2. The content determines what data pass method, if any, is in place.

3. The content determines what identifiers and existing data exist, if any

4. If data pass is available, the content writes a cookie to the user's hard drive using traditional browser conventions. This cookie contains the updated information from the database if the user is returning. If this is the first visit by the user, the cookie is populated with default settings that will change as the experience continues.

5. If data pass is not available, the content checks for a cookie. If one already exists, the user picks up where the cookie left them last. If no cookie is present, the content writes a cookie with default settings to the user's hard drive using traditional browser conventions.

6. The user begins an interactive experience with the content.

7. The process uses client side cookies to hold user experience data as the user proceeds through the content. If the content was launched from a server environment, the content will periodically send data back to the server through the appropriate method to maintain a connection and prevent data loss.

8. When the user exits the content, final data is written to the cookie on the hard drive.

9. The content notes the data pass type initially detected

10. The content passes variable data and cookie text back to the parent database if it is available. Once data pass has been successfully achieved, the cookie is erased to prevent data overflow.

11. The course exits.

These implementation files are the content files, the standard AICC files, the standard SCORM files, Oracle and MSSQL database scripts for those systems without a standards compliant database, P3P example files for IE 6.0 privacy settings, and both index and exit files for PHP, ASP and standard HTML.

The index and exit pages in the content package 103, 104 and 106 are the most relevant to the embodiment outlined above. The Index.PHP and the Index.ASP do basically the same thing, but for different environments. These files are designed to allow integration of content to occur in a proprietary (or non-standards compliant) server environment (described in detail below). At the end of each one, they point to the Index.HTML file that finishes up the data detection process, and the course experience begins.

At the end of the user experience, the Exit.PHP and Exit.ASP files are called by the Exit.HTML file upon realization that a proprietary (or non-standards compliant) server passed data into the content at the beginning of the experience. An example of program code associated with these files is provided in the attached Appendix.

A client starts the content package 103, 104 and 106 via the server 101. The content package 103, 104 and 106 will determine what data pass method, if any, is in place. The content package 103, 104 and 106 will also determine what identifiers and existing data exist, if any exist. If data pass to a data base 102 is available, the content package 103, 104 and 106 writes a cookie 105 to the user's hard drive using traditional browser conventions. The cookie 105 contains the updated information from the database 102 if the user is returning. If this is the first visit by the user, the cookie 105 is populated with default settings that will change as the experience continues.

If data pass is not available, the content package 103, 104 and 106 checks for a cookie 105. If one already exists, the user picks up where the cookie 105 left them last. If no cookie 105 is present, the content package 103, 104 and 106 writes a cookie 105 with default settings to the user's hard drive using traditional browser conventions. The user then begins an interactive experience with the content in the content package.

The content package 103, 104 and 106 uses client side cookies 105 to hold user experience data as the user proceeds through the content. If the content package 103, 104 and 106 has been launched from a server environment, the content will periodically send data back to the server through the appropriate method to maintain a connection and prevent data loss. When the user exits the content, final data is written to the cookie 105 on the hard drive. The content package 103, 104 and 106 notes the data pass type initially detected and passes variable data and cookie text back to the parent database 102 if it is available. Once data pass has been successfully achieved, the cookie may be erased to prevent data overflow. Then the course exits.

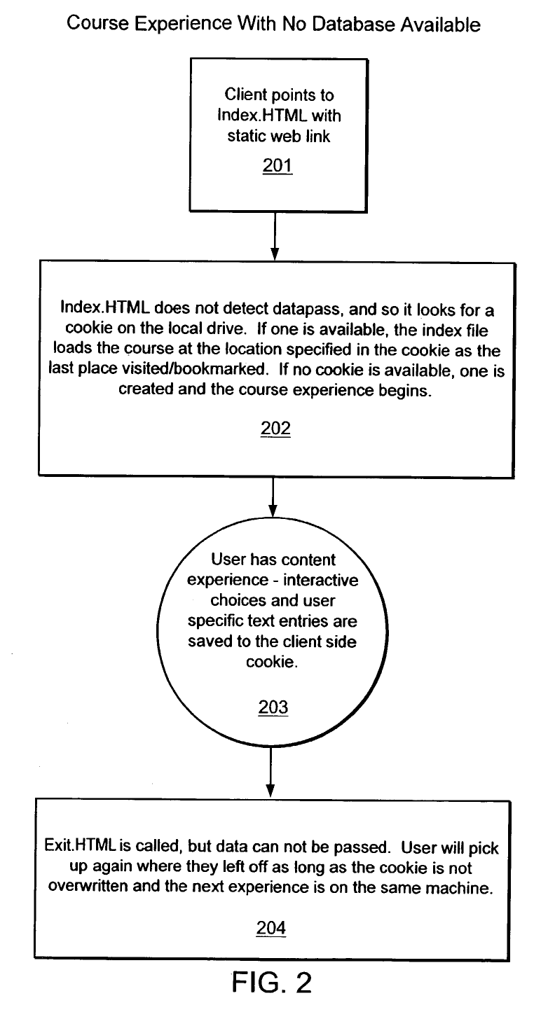

FIG. 2 is a flow chart illustrating a method for providing information when no database is available. If no database 102 is available, the client calls 201 the course Index file 103 in .HTML formal (Index.HTML) via a static Web link. The index.HTML does not detect data pass, and so it searches 202 for a cookie 105 on the local disk drive. If a cookie 105 is available, the index.HTML file loads the course at the location specified in the cookie 105 as the last place visited and/or bookmarked. If no cookie 105 is available, one is created, and the course content experience begins. The user has a course content experience, and interactive choices and user specific text entries are saved to the client side cookie 105 in process 203. The client calls, in process 204, the course Exit file 106 in .HTML format (Exit.HTML). Data cannot be passed, thus the user will pick up again where they left off as long as the cookie 105 is not overwritten and the next course experience is on the same user machine.

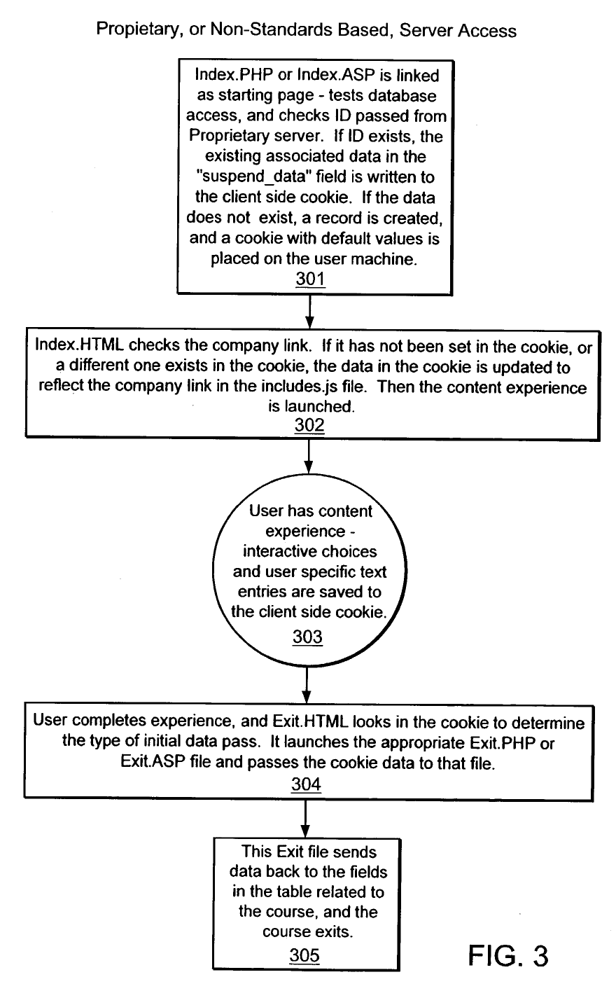

FIG. 3 is a flow chart illustrating a method for providing information in accordance with proprietary or non-standards based server access. Data base expansion scripts are provided to create a table in the users existing MSSQL or Oracle database environment. In accordance with this embodiment, the appropriate course Index file in .PHP or ASP format (Index.PHP or Index.ASP) is linked to a starting page. In process 301, the program code in the Index.PHP or Index.ASP file tests database access and checks the identification data passed from the proprietary server 101. If identification data exists, the existing associated data in a “suspend_data” field is written to the client side cookie 105. If identification data does not exist, a record is created, and a cookie 105 with default values is placed on the user's machine.

In process 302, in this particular embodiment, program code contained in the Index.HTML file causes checking of the client (or company) link in the cookie 105. If it has not been set in the cookie 105, or a different link exists in the cookie 105, the data in the cookie 105 is updated to reflect the company link in an “includes_js” file. (This particular implementation permits an optional company link, when present, to modify the structure of the content presentation.) The content experience is then launched. The user has a content experience, in process 303, and interactive choices and user specific text entries are saved to the client side cookie 105.

In process 304, the user completes the content experience, and the Exit.HTML file provides code that accesses the cookie 105 to determine the type of initial data pass that was used. The Exit.HTML code then launches the appropriate exit file (either the Exit.PHP file or the Exit.ASP file) and passes the cookie data to that file. The Exit.PHP file or Exit.ASP file also includes code that sends data back to the fields in a table related to the course, and the course exits in process 305.

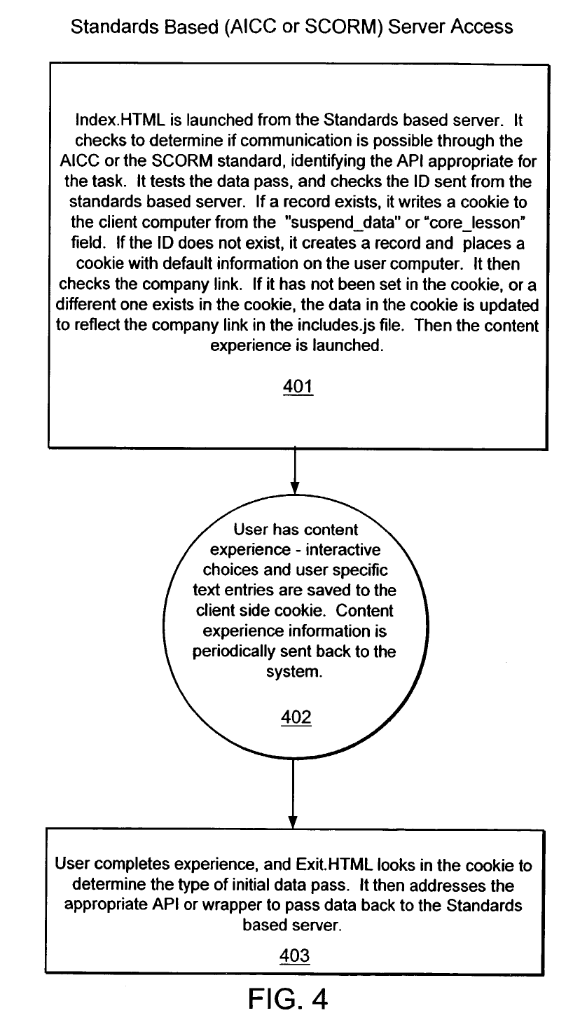

FIG. 4 is a flow chart illustrating a method for providing information in accordance with standards-based server access. In accordance with this embodiment, the Index.HTML file is launched 401 from a standards-based server. The Index.HTML file provides program code that checks to determine if communication is possible through the AICC or the SCORM standard and identifies the API appropriate for the task. The Index.HTML also provides program code that tests the data pass and checks the identification data sent from the standards-based server. If a record exists, the Index.HTML file provides program code to receive data and write a cookie 105 to the client computer from a “suspend_data” field or a “core_lesson” field. If the identification data does not exist, the Index.HTML file provides code to create a record and place a cookie 105 with default information on the user's computer. In this embodiment, the Index.HTML file also provides code to check the company or client link. If a link has not been sent to the cookie 105, or a different link exists in the cookie 105, the data in the cookie 105 is updated to reflect the company or client link in an “includes_js” file. The content experience is then launched.

The user has a content experience in process 402, interaction choices and user specific text entries are saved to the client side cookie and content experience information is periodically sent back to the system 105. In process 403, the user completes the content experience, and the Exit.HTML file provides program code that searches the cookie 105 to determine the type of initial data pass. The Exit.HTML file also provides code to address the appropriate API to pass data back to the standards-based server.

In a separate embodiment, a course engine uses XML or Winini to tie course information during course creation to the proper AICC and SCORM terms, and generates the same type of files as demonstrated above automatically, giving the course content the ability to self detect its environment and integrate into a clients environment simply.

The apparatus and methods described above, enable those systems with or without a database to provide an identical interactive experience to their users. They also allow the same content and course version to address all client distribution methods, regardless of their proximity to a central database.

There are differences in technical functionality in each implementation scenario, but they are found in every instance of content delivery in the scenario and not specifically a product of the invention.

Traditional Internet or Intranet Delivery (Proprietary or Standards Based Environment)

This is a solution like a traditional hosting solution available via an on-line site.

Features and trade-offs:

(a) The server hosts the course.

(b) The server manages user data.

(c) Reports are easily made available

(d) Data is persistent from session to session.

(e) Data is persistent from computer to computer.

Non-Database Distribution Through Internet/Intranet or CD/Hard Drive Use

This version allows a company or client to run content from a database-free Intranet, Internet, or hard drive installation or a CD distribution.

Features and trade-offs:

(a) The course lives on the client Intranet/Internet or user CD drive/desktop.

(b) Data is user specific and held on user machine.

(c) No completion reporting is possible.

(d) Data is persistent from session to session as long as the cookie is not over-written.

(e) Data is not persistent from computer to computer.

FIG. 5 is an illustration of a graphical user interface for accessing files in accordance with the embodiments of FIGS. 1-4. In accordance with this particular embodiment, “Managing Direct Reports” is a course that provides interactivity through an interactive case and short practice activities, along with expert feedback for self-evaluation. An “@Work” section with interactive online tools also helps the user prepare, practice, and review key concepts as they work. The content is written in HTML, using client side JavaScript to go through the steps outlined above. The course package also includes SCORM and AICC files for standards based server integration as well as PHP and ASP files for a proprietary server implementation.

The implementation files included in the package for this embodiment are provided in appropriate subfolders or stored directly in the directReportsFlat folder. Such files include the content files in folders such as 511, 512, 513, 514, 515, 516 and 517 the standard AICC files in folder 501, the standard SCORM files in folder 502, MSSQL (folder 503) and Oracle database scripts for those systems without a standards compliant database system, P3P example files in folder 504 for IE 6.0 privacy settings, and both index (in pages 505, 507 and 509) and exit files (506, 508 and 509) for PHP, ASP and standard HTML respectively.

The index and exit pages 509 and 510 in the package are the most relevant to the invention outlined above. The Index.PHP 505 and the Index.ASP 507 do basically the same thing, but for different environments. These files are designed to allow integration of content to occur in a proprietary (or non-standards compliant) server environment. At the end of each one, there is a pointer to the Index.html file 509 that finishes up the data detection process, and the course experience begins.

At the end of the user experience, the Exit.php 506 and Exit.asp 508 files are called by the Exit.html 510 file upon realization that a proprietary (or non-standards compliant) server passed data into the content at the beginning of the experience. The Index and Exit files and their associated code are also explained on the pages in Appendix A attached hereto.

In a separate embodiment, a course engine may use XML or Winini to tie course information during course creation to the proper AICC and SCORM terms, and generate the same type of files as described in accordance with the embodiment of FIG. 5. This automatically gives the content the ability to self-detect its environment and integrate into a clients environment simply.

Although various exemplary embodiments of the invention have been disclosed, it should be apparent to those skilled in the art that various changes and modifications can be made which will achieve some of the advantages of the invention without departing from the true scope of the invention.

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer product for providing interactive content for use in a computer system that optionally includes a network of computers, the computer product comprising:
a digital storage medium, the storage medium encoded with computer readable files as follows:
a first set of files providing interactive content using a markup language format and a script format, the scripting language for controlling data communication between a user and a program source;
a second set of files providing compatibility of the interactive content for use with a first e-learning standard environment; and
a third set of files providing compatibility of the interactive content for use with a second e-learning standard environment.

2. A computer product according to claim 1, further comprising a fourth set of files, which may be included in any of the other sets of files, for identifying the nature of an e-learning environment in which interactive content has been placed, and invoking processes for providing data pass consistent with the thus identified e-learning environment, or providing no data pass at all.

3. A computer product according to claim 1, wherein the first e-learning standard environment may comply with AICC standards.

4. A computer product according to claim 1, wherein the second e-learning standard environment may comply with SCORM standards.

5. A computer product according to claim 1, wherein the scripting language is selected from the group consisting of JavaScript, ASP script, and PHP script.

6. A method of providing interactive content, for use in a computer system that optionally includes a network of computers, comprising:
providing interactive content using a markup language format;
providing a first set of files providing compatibility of the interactive content for use with a first e-learning standard environment and a second set of files providing compatibility of the interactive content for use with a second e-learning standard environment;
identifying the nature of an e-learning environment in which interactive content has been placed;
using a cookie, for each user experiencing the interactive content, to provide a record of the user's place in experiencing of the interactive content.

7. A method according to claim 6, wherein the cookie provides a record of the user's data in experiencing of the interactive content.

8. A method according to claim 6, wherein the interactive content is provided in an environment devoid of a network of computers.
